(19) United States
(12) Patent Application Publication
(10) Pub. No.: US 2016/0143339 A1
(43) Pub. Date: May 26, 2016

(54) METHOD FOR IMPROVING FROTH RETENTION OF NON-ALCOHOL BEER-TASTE BEVERAGE, AND METHOD FOR PRODUCING NON-ALCOHOL BEER-TASTE BEVERAGE

(71) Applicant: ASAHI BREWERIES, LTD., Tokyo (JP)

(72) Inventor: Koji NAKAJIMA, Tokyo (JP)

(21) Appl. No.: 14/904,630

(22) PCT Filed: Jun. 17, 2014
(86) PCT No.: PCT/JP2014/065986

§ 371 Date: Jan. 12, 2016

(30) Foreign Application Priority Data
Aug. 5, 2013 (JP) 2013-162336

(51) Int. Cl. A23L 2/54; A23L 2/52

(52) U.S. Cl. CPC A23L 2/54; A23L 2/52; A23V 2002/00

(57) ABSTRACT

The present invention provides a method for improving the froth retention of a non-alcohol beer-taste beverage, and a method for producing a non-alcohol beer-taste beverage having improved froth retention. The present invention relates to a method for improving the froth retention of a non-alcohol beer-taste beverage, wherein the lysine content is increased to 0.01 mM or more, the arginine content is increased to 0.01 mM or more, or the tyrosine content is increased to 0.05 mM or more in the final product; and a method for producing a non-alcohol beer-taste beverage which uses a raw material having a high content of lysine, arginine or tyrosine.

### TECHNICAL FIELD

The present invention relates to a method for improving the froth retention of a non-alcohol beer-taste beverage, and a method for producing a non-alcohol beer-taste beverage using that method.

### BACKGROUND ART

In beer-taste beverages such as beer and low-malt beer (happoshu), the froth is an important external appearance quality. The quality of the froth is mainly evaluated in terms of froth formation, froth retention and froth adhesion. The froth in beer is mainly due to foam protein derived from malt, and the relationship between the protein and froth quality in beer-taste beverages has also been investigated. For example, it is known that if basic amino acids (arginine, lysine, histidine) are added to beer, then the adhesion of the froth deteriorates, namely, the adhesion of the froth is inhibited by basic amino acids (for example, see Non-Patent Document 1). Further, a method for improving the froth retention of beer-taste beverages by adding soybean dietary fiber, soybean protein or a decomposition product of soybean protein to increase the protein content is also known (for example, see Patent Document 1).

In recent years, refreshing beverages which have a beer-taste, but which are not classified as liquor under the Liquor Tax Act due to a reduction in the alcohol content to less than 1% by mass (so-called non-alcohol beer-taste beverages) are becoming increasingly popular among consumers. Among non-alcohol beer-taste beverages, in terms of having beer-like qualities, good froth retention is preferable. However, non-alcohol beer-taste beverages generally tend to have unsatisfactory froth retention compared with beer and the like.

### PRIOR ART LITERATURE

### Patent Document

Patent Document 1: Japanese Unexamined Patent Application, First Publication No. 2008-136412

### Non-Patent Document

Non-Patent Document 1: “Biiru no Kihon Gijutsu” (Basic Techniques for Beer), edited by the Brewers Association of Japan, published by Brewing Society of Japan, 2002, page 127.

### DISCLOSURE OF INVENTION

### Problems to be Solved by the Invention

The present invention has an object of providing a method for improving the froth retention of a non-alcohol beer-taste beverage, and a method for producing a non-alcohol beer-taste beverage using that method.

### Means for Solving the Problems

As a result of intensive research aimed at achieving the above object, the inventors of the present invention discovered that by increasing the amount of lysine, arginine or tyrosine in a non-alcohol beer-taste beverage, the froth retention could be improved, and they were therefore able to complete the present invention.

In other words, a method for improving the froth retention of a non-alcohol beer-taste beverage and a method for producing a non-alcohol beer-taste beverage according to the present invention include the [1] to [8] described below.

[1] A method for improving the froth retention of a non-alcohol beer-taste beverage, wherein during the production process, the lysine content is increased to 0.01 mM or more, the arginine content is increased to 0.01 mM or more, or the tyrosine content is increased to 0.05 mM or more in the final product.

[2] A method for producing a non-alcohol beer-taste beverage, comprising a step within the production process of adding at least one amino acid selected from the group consisting of lysine, arginine and tyrosine, as an amino acid.

[3] A method for producing a non-alcohol beer-taste beverage that includes a raw material charging step and a carbon dioxide gas introduction step, wherein in the raw material charging step, a raw material having a high content of at least one amino acid selected from the group consisting of lysine, arginine and tyrosine is used.

[4] The method for producing a non-alcohol beer-taste beverage disclosed above in [2], wherein the lysine, arginine or tyrosine is added as an amino acid to a sugar solution prepared from raw materials.

[5] The method for producing a non-alcohol beer-taste beverage disclosed above in [2], wherein the amount added of the lysine, arginine or tyrosine is sufficient to increase the lysine content to 0.01 mM or more, the arginine content to 0.01 mM or more, or the tyrosine content to 0.05 mM or more in the final product.

[6] The method for producing a non-alcohol beer-taste beverage disclosed above in [3], wherein the raw material having a high content of the amino acid is a soybean protein decomposition product, and this soybean protein decomposition product is added in the raw material charging step in an amount of 0.01 to 3 (mass/volume)% relative to the sugar solution.

[7] The method for producing a non-alcohol beer-taste beverage disclosed above in [6], wherein the weight-average molecular weight of the soybean protein decomposition product is 150 or more.

[8] The method for producing a non-alcohol beer-taste beverage disclosed above in any one of [2] to [7], wherein potassium gluconate is also used as a raw material.

[9] The method for producing a non-alcohol beer-taste beverage disclosed above in any one of [2] to [8], wherein the method does not have a step of fermenting the sugar solution.

### Effects of the Invention

By employing the method for improving the froth retention of a non-alcohol beer-taste beverage and the method for producing a non-alcohol beer-taste beverage according to the present invention, a non-alcohol beer-taste beverage can be provided which, despite being a non-alcohol beer-taste beverage, has good froth retention and is highly palatable.

### BRIEF DESCRIPTION OF THE DRAWINGS

FIG. 1 illustrates the results of measuring the NIBEM value for three commercially available non-alcohol beer-taste beverages and one beer in Reference Example 1.

FIG. 2 illustrates the results of measuring the NIBEM value for each non-alcohol beer-taste beverages in Example 1.

FIG. 3 illustrates the results of measuring the NIBEM value for each non-alcohol beer-taste beverages in Example 2.

FIG. 4 illustrates the results of measuring the NIBEM value for each non-alcohol beer-taste beverages in Example 3.

FIG. 5 illustrates the results of measuring the NIBEM value for each non-alcohol beer-taste beverages in Example 4.

### EMBODIMENTS FOR CARRYING OUT THE INVENTION

In the present invention and the description of this application, a non-alcohol beer-taste beverage refers to an effervescent non-alcohol beverage which has the same or similar flavor, taste and texture to beer, and also provides excellent thirst quenching and drinkability. Further, a non-alcohol beverage means a beverage that either contains no alcohol, or has an alcohol content of less than 1% by volume. In the present invention, the non-alcohol beer-taste beverage for which the froth retention is improved may be a fermented beverage that is produced via a fermentation step using yeast, but is preferably a non-fermented beverage produced without using a fermentation step.

The method for improving the froth retention of a non-alcohol beer-taste beverage according to the present invention (hereafter also referred to as “the method for improving froth retention according to the present invention”) is a method in which, during the production process, the lysine content is increased to 0.01 mM or more, the arginine content is increased to 0.01 mM or more, or the tyrosine content is increased to 0.05 mM or more in the final product. The larger the amount of lysine, arginine or tyrosine dissolved in the non-alcohol beer-taste beverage, the more the froth retention is improved. The fact that the froth retention of a non-alcohol beer-taste beverage can be improved by specific amino acids including lysine and arginine is a finding that was first discovered by the inventors of the present invention. In beer, because the addition of basic amino acids such as lysine and arginine is known to impair adhesion of the froth, conventionally, the addition of lysine or the like to beer-taste beverages for improving other froth qualities such as the froth retention has not been attempted.

In the method for improving froth retention according to the present invention, during the production process, by increasing the lysine, arginine or tyrosine content in the final product, either to 0.01 mM or more in the case of lysine or arginine, or 0.05 mM or more in the case of tyrosine, the froth retention can be distinctly improved compared with the case prior to the increase. The upper limit for the increased amount of each of these three amino acids may be the increased concentration at which the amino acid can still be dissolved in a stable manner. For example, when the increased amino acid is lysine or arginine, the concentration is preferably increased to 0.02 to 5 mM, and more preferably increased to 0.02 to 2 mM. Further, when the increased amino acid is tyrosine, the concentration is preferably increased to 0.05 to 1 mM, and more preferably increased to 0.05 to 0.08 mM.

In order to increase the amount of lysine, arginine or tyrosine in the final product, the amino acid such as lysine may be added directly to the non-alcohol beer-taste beverage during the production process to produce the final product, or the amino acid such as lysine may be added directly as a raw material during the raw material charging step in the production process for the non-alcohol beer-taste beverage. Alternatively, the raw materials used in the raw material charging step of the production process for the non-alcohol beer-taste beverage may be substituted with raw materials having a high content of the amino acid such as lysine.

The method for producing a non-alcohol beer-taste beverage according to the present invention (hereafter also referred to as “the method for producing a beverage according to the present invention”) includes, specifically, either adding at least one amino acid selected from the group consisting of lysine, arginine and tyrosine, as an amino acid, during the production process, or using a raw material having a high content of at least one amino acid selected from the group consisting of lysine, arginine and tyrosine (hereafter also described as “the raw material having a high content of lysine or the like”) in the raw material charging step.

A raw material having a comparatively high amino acid content such as a protein, protein decomposition product or grain raw material can be used as the raw material having a high content of lysine or the like used in one aspect of the present invention. For example, in the case where a grain raw material such as a malt is used, a malt may be selected which has a comparatively high content of at least one amino acid among lysine, arginine and tyrosine compared with other grain materials of the same type. Further, in those cases where a protein or protein decomposition product is used as a raw material, a protein having a comparatively high content of at least one amino acid etc. among lysine, arginine and tyrosine is used. In such a case, any raw material having a high content of lysine or the like relative to the total amount of the raw material may be used, but a raw material having a high content of free lysine, arginine or tyrosine is particularly preferable.

In one aspect of the method for producing a beverage according to the present invention, with the exception of using a raw material having a high content of lysine or the like in the raw material charging step, production may be performed in the same manner as typical non-alcohol beer-taste beverages. The production process for a typical non-fermented non-alcohol beer-taste beverage is described below. By not including a fermentation step using yeast, a non-alcohol beer-taste beverage such as a non-alcohol beer can be produced easily.

A non-alcohol beer-taste beverage produced using a malt as a raw material is produced via the steps described below. First, in a raw material charging step, a mixture containing a grain raw material and water is saccharified and then boiled to prepare a wort. Specifically, hot water is added to a ground malt that represents the main raw material and a starch secondary raw material such as rice or corn starch, and the mixture is heated to saccharify the starch using mainly the enzymes of the malt. In those cases where hops are added to the raw material, the hops are added to the filtrate obtained by filtering the saccharified liquid, and the resulting mixture is then boiled. Alternatively, instead of using the filtrate of the saccharified liquid, the hops may be added to a solution prepared by adding hot water to a malt extract, and the resulting mixture then boiled. The hops may be mixed at any stage from the start of the boiling process to a stage prior to the completion of the boiling process.

Following boiling of the saccharified liquid, the obtained wort is filtered, a carbon dioxide gas introduction step is performed, either by adding carbon dioxide gas to the obtained filtrate, or by adding carbon dioxide gas to the wort or the like prepared in the aforementioned charging step and then performing filtration, and the filtrate is then collected to obtain the targeted non-alcohol beer-taste beverage.

When a non-alcohol beer-taste beverage is produced without using malt as a raw material, a raw material charging step is first performed by mixing a liquid sugar containing a carbon source, a nitrogen source composed of an amino acid-containing material other than barley or malt, hops and a colorant and the like with hot water to prepare a liquid sugar solution. The liquid sugar solution is then boiled in the same manner as the production process for a non-alcohol beer-taste beverage that uses a malt as a raw material. In those cases where hops are used as a raw material, the hops may be mixed with the liquid sugar solution, not at the start of the boiling process, but partway through the boiling process. Following boiling, the liquid sugar solution is subjected to a carbon dioxide introduction step in the same manner as the production process for a non-alcohol beer-taste beverage that uses a malt as a raw material, thus obtaining the targeted non-alcohol beer-taste beverage.

The beer-taste beverage obtained following the carbon dioxide gas introduction step is usually bottled in a filling step, and then shipped as a final product. The filtration method and the carbon dioxide gas addition method conducted in the carbon dioxide gas introduction step may be performed using normal methods. Further, in addition to the carbon dioxide gas, sugars, grain syrups, grain extracts, dietary fiber, fruit juices, bittering agents, colorants, herbs and spices may also be added.

In the method for producing a beverage according to the present invention, the raw material having a high content of lysine or the like may be added at any stage (sub-step) during the raw material charging step. For example, the raw material having a high content of lysine or the like may be added at the stage of preparing the sugar solution (the wort in the case where a malt is used as a raw material, or the liquid sugar solution in the case where a malt is not used as a raw material) in the raw material charging step, may be added to the sugar solution prior to the boiling process, or alternatively, may be added to the sugar solution after boiling and immediately prior to the carbon dioxide gas introduction step. Moreover, when the lysine, arginine or tyrosine is added in the form of an amino acid, the amino acid may not only be added at any of the above stages, but may also be added to the sugar solution after the carbon dioxide gas introduction step. When the raw material having a high content of lysine or the like is the amino acid itself, a protein or a protein decomposition product, in order to facilitate dissolution of the raw material, the time at which the raw material is added to the sugar solution is preferably in the period from the sugar solution preparation stage until the completion of the boiling treatment, and is more preferably in the period from the completion of the preparation of the sugar solution until the end of the boiling treatment.

There are no particular limitations on the ground malt, the starch such as rice or corn starch, the hops, the liquid sugar containing a carbon source, the nitrogen source composed of an amino acid-containing material other than barley or malt, and the colorant which are used as raw materials in the method for producing a beverage according to the present invention, and the types of raw materials typically used in the production of beer-taste beverages can be used in typical amounts.

In the method for producing a beverage according to the present invention, a protein or protein decomposition product is preferably also used as a raw material. By using a protein or the like as a raw material, any lack of foaming protein can be supplemented, enabling a further improvement in the froth retention.

The protein or protein decomposition product used as a raw material may be any protein decomposition product derived from plants, derived from animals, or derived from microbes, but a soybean protein decomposition product is particularly preferred. This is because soybeans have extremely good nutritional properties and also exhibit good digestibility and absorbability, and therefore complement the recent increase in health awareness among consumers.

The protein decomposition product may use a product obtained by subjecting the tissue or a culture solution of a plant or the like that represents the raw material to extraction, purification and separation, and then performing a decomposition. For example, a soybean protein decomposition product can be obtained by performing a water extraction and acid precipitation of defatted soybeans that have been prepared by defatting soybeans, and then isolating and decomposing the separated soybean protein curd. Any method that enables partial decomposition of the protein can be used as the decomposition method without any particular restrictions. Examples include decomposition by heat or pressure, decomposition by acid or alkali, and decomposition by enzyme. An enzyme decomposition method is simple and can be easily controlled, and is therefore preferred.

The weight-average molecular weight of the soybean protein decomposition product or the like used as a raw material is preferably 150 or more, more preferably from 150 to 35,000, still more preferably from 150 to 10,000, and most preferably from 150 to 500.

The protein decomposition product is used as a raw material of the sugar solution prepared in the raw material charging step. There are no particular limitations on the time at which the protein decomposition product is added, provided the addition is performed before the carbon dioxide gas introduction step (in other words, either before the carbon dioxide gas introduction, or before the filtration performed as a pretreatment), but the protein decomposition product is preferably added and mixed after the saccharification treatment, and is more preferably added and mixed in the period from the completion of the saccharification treatment until the completion of the boiling treatment of the sugar solution.

Although there are no particular limitations on the amount of the protein decomposition product used as a raw material, the protein decomposition product is preferably added to the sugar solution in an amount from 0.01% (mass/volume) to 3% (mass/volume).

The pH of non-alcohol beer-taste beverages is generally about 3.7, but as the amount of basic amino acids in the final product is increased, the pH tends to increase. On the other hand, when a protein decomposition product is used as a raw material, the buffering action of the solution tends to deteriorate depending on the amount added of the protein decomposition product, and as a result, the pH tends to decrease to 3.3 to 3.5. Accordingly, in the method for producing a beverage according to the present invention, an edible organic acid or organic base is preferably also added as a raw material to adjust the pH to about 3.7. Examples of organic acid salts that may be used as acid modifiers include sodium gluconate, potassium gluconate and sodium ascorbate, and potassium gluconate is particularly preferred because it provides superior flavor characteristics.

### EXAMPLES

The present invention is described below in further detail using a series of examples and a reference example, but the present invention is in no way limited by the examples presented below.

### <Measurement of Froth Retention (NIBEM)>

In the following examples and the reference example, the NIBEM value of each non-alcohol beer-taste beverage was measured in the manner described below. First, an aqueous solution at 20° C. contained in a bottle or a can was foamed, while being forced into a cylindrical glass having an inner diameter of 60 mm and a height of 120 mm from the liquid bottom surface by a carbon dioxide flow rate of 1,500 to 1,700 mL/min, thereby filling the glass with foam. Subsequently, the time taken for the surface of the foam to collapse from a starting point at a surface 10 mm from the top rim of the glass to a surface 40 mm below that starting point was measured automatically with an electrode contact sensor. This measured numerical value was recorded as the NIBEM value (seconds).

### Reference Example 1

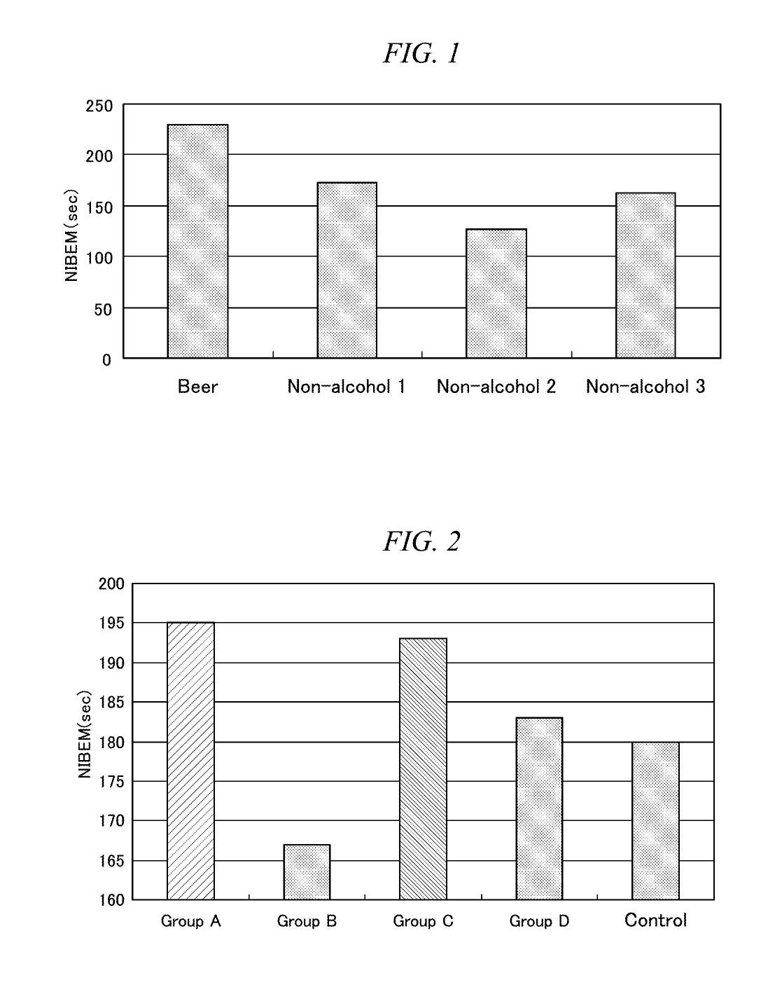

At first glance, non-alcohol beer-taste beverages generally appear to have similar froth to genuine beers, but the froth retention (NIBEM value) of three commercially available non-alcohol beer-taste beverages and one beer were compared. The measurement results are shown in FIG. 1. The results revealed that whereas the NIBEM value for the beer was about 230, the three non-alcohol beer-taste beverages each had a NIBEM value of 170 or less. In other words, the NIBEM values for the non-alcohol beer-taste beverages were distinctly lower than that of the beer, confirming that the froth retention was inferior.

### Example 1

2.5 mL of each of the amino acid solutions described below (concentration of each amino acid: 70.5 mM) was added to a commercially available non-alcohol beer-taste beverage (350 mL) that did not use a malt as a raw material but used soybean dietary fiber, thus producing a series of non-alcohol beer-taste beverages in which each amino acid concentration had been increased to 0.5 mM, and the NIBEM value of each beverage was then measured. In the case of group C, because the solubility was low, the amino acid was added directly and an additional 2.5 mL of water was added. A beverage in which 2.5 mL of water was added instead of an amino acid solution was used as a control.

Group A: basic amino acids (arginine, lysine, histidine)

Group B: acidic amino acids (aspartic acid, glutamic acid)

Group C: neutral amino acids (phenylalanine, tyrosine)

Group D: branched amino acids (valine, leucine, isoleucine)

The results of measuring the NIBEM value of each of the non-alcohol beer-taste beverages are shown in FIG. 2. The results revealed that the non-alcohol beer-taste beverage to which the amino acid solution of group A had been added, and the non-alcohol beer-taste beverage to which the amino acid solution of group C had been added exhibited NIBEM values that were distinctly higher than the NIBEM value of the control non-alcohol beer-taste beverage to which no amino acid solution had been added, indicating that the froth retention had been improved.

### Example 2

The amino acids of group A used in Example 1 were added to non-alcohol beer-taste beverage samples (350 mL) from a different production lot of the same commercially available product as Example 1 to produce non-alcohol beer-taste beverages in which each amino acid concentration had been increased to 0.01 mM, 0.05 mM, 0.5 mM or 1 mM, and the NIBEM value of each beverage was then measured.

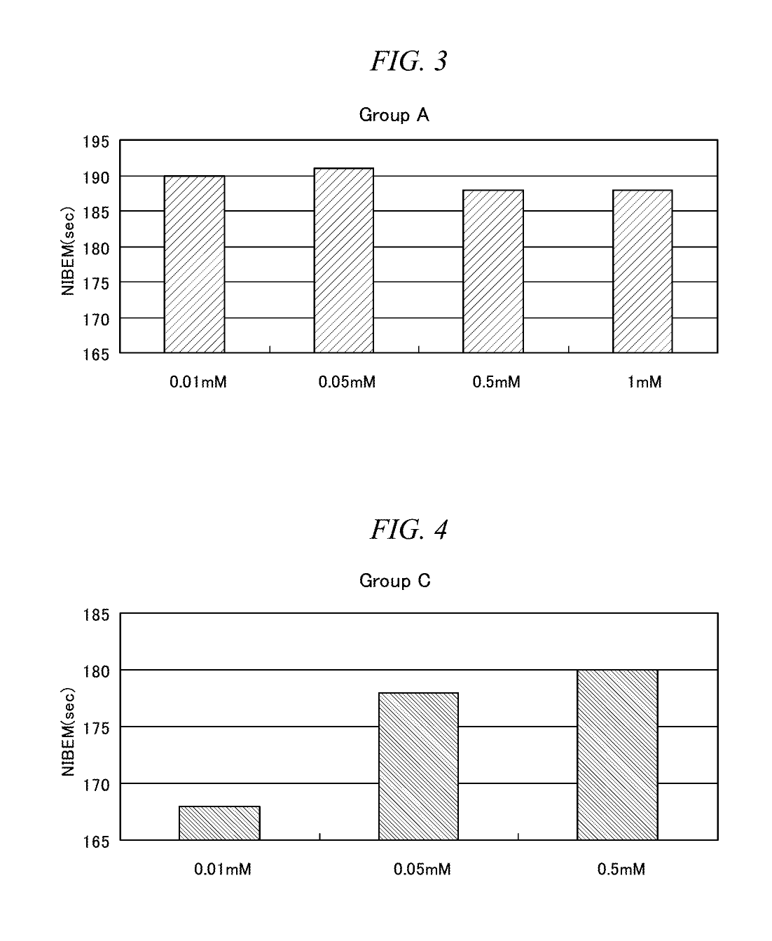

The results of measuring the NIBEM value of each of the non-alcohol beer-taste beverages are shown in FIG. 3. The NIBEM value for the control non-alcohol beer-taste beverage was 165 seconds. The results revealed that for each of the non-alcohol beer-taste beverages to which the basic amino acids of group A had been added, the NIBEM value was higher than that of the control. In other words, it was found that by increasing the concentration of each basic amino acid to 0.01 mM or more, the froth retention could be improved.

### Example 3

The amino acids of group C used in Example 1 were added to samples (350 mL) of the commercially available non-alcohol beer-taste beverage used in Example 2 to produce non-alcohol beer-taste beverages in which each amino acid concentration had been increased by 0.01 mM, 0.05 mM or 0.5 mM, and the NIBEM value of each beverage was then measured.

The results of measuring the NIBEM value of each of the non-alcohol beer-taste beverages are shown in FIG. 4. The NIBEM value for the control non-alcohol beer-taste beverage was 165 seconds. The results revealed that for the non-alcohol beer-taste beverages to which the neutral amino acids of group C had been added in an amount sufficient to increase the concentration of each amino acid to 0.05 mM or more, the NIBEM value was higher than that of the control. In other words, it was found that by increasing the concentration of each neutral amino acid to 0.05 mM or more, the froth retention could be improved.

### Example 4

Each of the amino acids from groups A and C used in Example 1 was added individually to a sample (350 mL) of the commercially available non-alcohol beer-taste beverage used in Example 1 to increase the final concentration of the amino acid to at least 0.5 mM, and the NIBEM value of each of the obtained non-alcohol beer-taste beverages was then measured. A sample to which no amino acid had been added was used as a control.

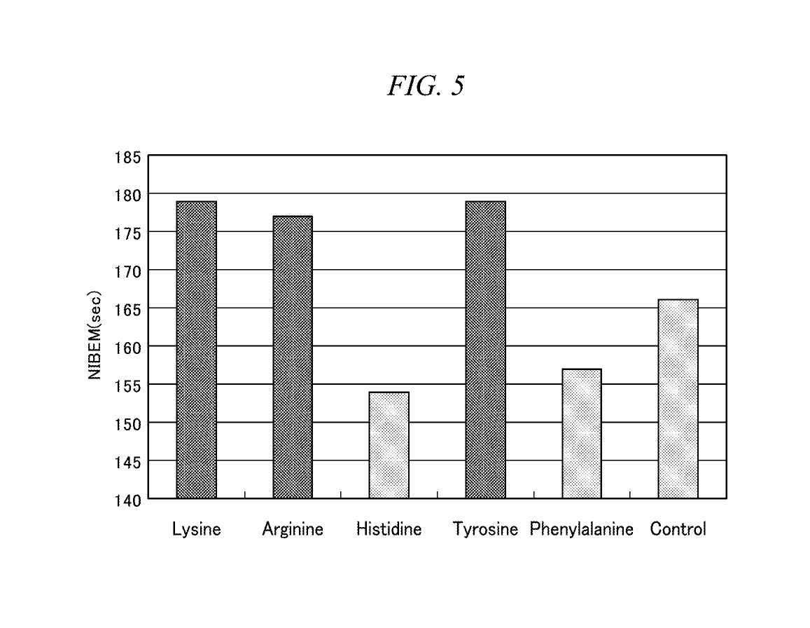

The results of measuring the NIBEM value of each of the non-alcohol beer-taste beverages are shown in FIG. 5. The results revealed that for the non-alcohol beer-taste beverages to which lysine, arginine or tyrosine had been added, the NIBEM value was distinctly higher than that of the control non-alcohol beer-taste beverage to which no amino acid had been added, indicating improved froth retention.

### Example 5

Using a non-fermented non-alcohol beer-taste beverage containing a soybean protein decomposition product (test item 1) as a control, appropriate amounts of lysine, arginine and tyrosine were added to samples of this test item 1 to produce three non-alcohol beer-taste beverages (test items 2 to 4) containing different amounts of lysine, arginine and tyrosine in the final product beverage, and the froth retention of each beverage was then investigated.

The test items 1 to 4 were obtained by first mixing all the raw materials to prepare a sugar solution (200 L), and then adding sufficient carbon dioxide gas to the obtained sugar solution to produce a gas volume of 2.3. The composition of the test item 1 included 30 g/L of a 67% sucrose liquid sugar, 0.35 g/L of citric acid, 1.0 g/L of SOYAFIBE-S-LN (a product name, manufactured by Fuji Oil Co., Ltd.), 3 g/L of HINUTE AM (a product name, manufactured by Fuji Oil Co., Ltd.), 0.3 g/L of liquid caramel SP, and 0.1 g/L of a hops extract (all values represent final concentrations). HINUTE AM is a soybean oligopeptide containing mainly dipeptides and tripeptides, and has a weight-average molecular weight of 200 to 300. Further, in the case of the test item 4 only, potassium gluconate was also added to adjust the pH to 3.7.

TABLE 1

| | Test item | Test item | Test item | Test item |
|---|---|---|---|---|
| | 1 (control) | 2 | 3 | 4 |
| Potassium | 0.00 | 0.00 | 0.00 | 0.25 |
| gluconate (ppm) | | | | |
| Lysine (mM) | 0.03 | 0.12 | 0.06 | 0.05 |
| Arginine (mM) | 0.13 | 0.29 | 0.15 | 0.21 |
| Tyrosine (mM) | 0.00 | 0.02 | 0.01 | 0.02 |
| NIBEM (seconds) | 173 | 295 | 255 | 242 |

The concentration levels of potassium gluconate, lysine, arginine and tyrosine, the pH, and the result of measuring the NIBEM value for each of the test items 1 to 4 are shown in Table 1. The results revealed that in each of the test items 2 to 4, in which the concentrations of lysine, arginine and tyrosine had been increased, the NIBEM value was distinctly higher than that of the test item 1, indicating improved froth retention. In particular, the test item 4, the pH of which was adjusted to 3.7 by adding potassium gluconate, was a non-alcohol beer-taste beverage that not only exhibited superior froth retention, but also had an excellent flavor.

### INDUSTRIAL APPLICABILITY

The present invention enables the production of a highly palatable non-alcohol beer-taste beverage having favorable froth retention.

1. A method for improving froth retention of a non-alcohol beer-taste beverage, comprising:
adding, during production, lysine, arginine, or tyrosine to a raw material or a non-alcohol beer-taste beverage; or
using a raw material with a high content of lysine, arginine or tyrosine;
so that a lysine content is increased to 0.01 mM or more, an arginine content is increased to 0.01 mM or more, or a tyrosine content is increased to 0.05 mM or more in a final product.

2. A method for producing a non-alcohol beer-taste beverage, comprising a step of adding at least one amino acid selected from the group consisting of lysine, arginine and tyrosine, as an amino acid, during the production of the non-alcohol beer-taste beverage.

3. A method for producing a non-alcohol beer-taste beverage, comprising:
a raw material charging step, in which a raw material having a high content of at least one amino acid selected from the group consisting of lysine, arginine and tyrosine is used, and a carbon dioxide gas introduction step.

4. The method for producing a non-alcohol beer-taste beverage according to claim 2, wherein the lysine, arginine or tyrosine is added as an amino acid to a sugar solution prepared from raw materials.

5. The method for producing a non-alcohol beer-taste beverage according to claim 2, wherein an amount added of the lysine, arginine or tyrosine is sufficient to increase a lysine content to 0.01 mM or more, an arginine content to 0.01 mM or more, or a tyrosine content to 0.05 mM or more in a final product.

6. The method for producing a non-alcohol beer-taste beverage according to claim 3, wherein the raw material having a high content of the amino acid is a soybean protein decomposition product, and the soybean protein decomposition product is added in the raw material charging step in an amount of 0.01 to 3 (mass/volume)% relative to a sugar solution.

7. The method for producing a non-alcohol beer-taste beverage according to claim 6, wherein a weight-average molecular weight of the soybean protein decomposition product is 150 or more.

8. The method for producing a non-alcohol beer-taste beverage according to claim 2, wherein potassium gluconate is also used as a raw material.

9. The method for producing a non-alcohol beer-taste beverage according to claim 2, wherein the method does not have a step of fermenting a sugar solution.
